(19) United States
(12) Patent Application Publication
(10) Pub. No.: US 2011/0119222 A1
(43) Pub. Date: May 19, 2011

(54) METHOD OF BUILDING A DATABASE OF MOBILE DEVICE BEACON LOCATIONS

(75) Inventor: Martin Rosinski, Northumberland (GB)

(73) Assignee: Palringo Limited, Northumberland (GB)

(21) Appl. No.: 12/994,196

(22) PCT Filed: May 26, 2009
(86) PCT No.: PCT/GB2009/050568

§ 371 Date: Jan. 19, 2011

(30) Foreign Application Priority Data
May 23, 2008 (GB) 0809344.5
Aug. 29, 2008 (GB) 0815726.5

(51) Int. Cl. G06F 17/30; G06N 5/02

(52) U.S. Cl. 706/50; 707/812; 707/E17.005

(57) ABSTRACT

A method of building a database of beacon locations is disclosed. Mobile devices submit beacon sighting data to a server; the server using the beacon sighting data to build the database of beacon locations using force directed graph calculations. An iterative process calculates the optimal placement of beacons in a 2D or 3D topology of nodes and edges using force directed graph calculations.

### BACKGROUND OF THE INVENTION

1. Field of the Invention

This invention relates to a method of building (e.g. creating, populating, updating or improving) a database of beacon locations. Beacons are the stations used to receive and transmit signals to mobile devices, such as mobile telephones, cell phones, smart phones, laptop computers and any other kinds of mobile wireless information device with voice and/or data capabilities. Beacons may transmit and receive data using GSM, WCDMA, UMTS, LTE, Wi-Fi, Bluetooth or any other wireless system or protocol. Beacons may be GSM, WCDMA etc basestations of any size, including large, fixed cell towers, as well as much smaller basestations, such as picocells and femtocells.

2. Technical Background

Mobile devices can execute software to periodically report unique identifiers and signal strengths of visible beacons. However, if accurate positions of the visible beacons are not known, it may not be possible to determine the position of the devices. So it is very important to have an accurate database of beacon locations. Knowing the location of a device is very useful because that information can be included in the ‘presence’ information of a network subscriber, can allow tracking and ‘buddy-finder’ services and can enable other kinds of location based services.

3. Discussion of Related Art

If we know the positions of the beacons sighted by a mobile device, it is trivial to make an educated guess as to the location of the device, using simple trilateration algorithms. This is demonstrated in FIG. 1, which demonstrates a method according to the prior art. Based on signal strength measurements for each beacon, an estimate is made for the likely distance from each beacon. In FIG. 1, each area between two concentric circles shows the possible position of a user with respect to a beacon, based on the signal strength received from the beacon at the user's position. The user position is determined, as shown, to be in the region defined by the intersection region of the three areas, where each area is the area between two concentric circles, and where each circle is centred on a beacon.

If we want to know the location of a mobile device, one option would be to use the Location Based Services (LBS) services provided by the network operators. Unfortunately, not all operators offer Location application programming interfaces (APIs). Furthermore, the pricing scheme for such services usually involves per-lookup costs, making them unviable for real-time tracking of a large user base.

The traditional approach for implementing operator-independent location based services involves building up a database of beacon/cell site locations by using GPS-enabled devices to survey the target area. Surveying a wide area can be prohibitively expensive and generally requires vehicles to take a carefully designed route to ensure that comprehensive, unbiased coverage is achieved. This can be costly and time-consuming. Reference may be made to US 2006217131, for example.

Force directed graph calculations or algorithms are well known techniques for modelling physical systems; the purpose of a force directed graph is to position nodes in a 2D or 3D space by modelling edges that link nodes. The edges are typically modelled as physical forces, such as for example a spring force operating between a node pair, with the spring force being described by Hooke's Law. A network topology can hence be modelled as a physical system. The typical force directed graph algorithm is an iterative algorithm that can build a representation of a network topology that converges to an accurate representation as more data about the topology is provided. In this specification, the term ‘force directed graph’ refers to any iterative process that models a network topology as a physical system made up of nodes and edges, or their equivalent.

### SUMMARY OF THE INVENTION

The invention is a method of building a database of beacon locations for a hardware system including mobile devices, beacons, and at least one server; the method comprising the steps of:
(i) the mobile devices submitting beacon sighting data to the server;
(ii) the server using the beacon sighting data to build the database of beacon locations using force directed graph calculations.

In an implementation, the beacon sighting data includes an ID for each beacon and signal strength data associated with each beacon; and an iterative process calculates the optimal placement of beacons in a 2D or 3D topology using force directed graph calculations without the need for any of the mobile devices to follow a re-defined route. The 2D or 3D topology includes (a) nodes that represent points with unknown locations, such as beacons, or the user's location at the time of a reported sighting and (b) edges that represent connections between pairs of nodes that are likely to be proximate.

The location of an individual mobile device is inferred or derived from its distance from each of several beacons, the location of each of those beacons being listed in the database of beacon locations. The location of an individual mobile device can be used in an instant messaging application (and social networking application) running on or accessed by a different mobile device. Further details are in the appended claims.

Another aspect of the invention is a hardware system including mobile devices, beacons, and at least one server; in which:
(i) the mobile devices submit beacon sighting data to the server;
(ii) the server uses the beacon sighting data to build the database of beacon locations using force directed graph calculations.

A final aspect of the invention is a method of providing instant messaging in which the location of an individual mobile device is inferred or derived from a database of beacon locations and that location is used in an instant messaging application running on or accessed by a different mobile device, the database of beacon locations having been built using the method defined above.

### BRIEF DESCRIPTION OF THE DRAWINGS

FIG. 1 shows a prior art method in which if we know the positions of all the sighted beacons, it is trivial to make an educated guess as to the location of the device, using simple trilateration algorithms.

FIG. 2 shows an example of a “PLS SUBMIT” packet sent to a server, which contains details (cell ID and signal strength data) on all sighted beacons, in addition to GPS fix details if available.

FIG. 3 shows an example in which a ring at an unknown position is connected by three springs to three rings at known positions.

FIG. 4 shows an example in which a user is driving down the A1 national route number in England. She passes a known cell, followed by two unknown cells, before sighting another known cell.

FIG. 5 shows, following from FIG. 4, a later point in time, in which the unknown beacons from FIG. 4 are once again sighted, by a GPS-enabled device which is not on the A1 national route but is instead on another road, as shown by the position of the user to the right hand side of this Figure. The algorithm refines the estimates for the unknown nodes based on the new information, giving a more accurate layout for the mesh, shown in this Figure.

FIG. 6 shows visualisation of data collected from a single journey from Cramlington to Ponteland in England. Circular nodes were previously known. Square nodes show estimated positions for sighted nodes.

FIG. 7 shows output from a module which is used to infer a phone's location.

FIG. 8 shows an example in which the location of users is displayed as a strapline on the contact list.

FIG. 9 shows an overview screen section which lists other service users who are nearby.

FIG. 10 shows an example of HyperText Markup Language (HTML) snippets which can be pasted into websites, blogs, social networking sites, etc.

FIG. 11 shows an example of highlighting of cells and sector information used to infer location.

FIG. 12 shows an example of a service Site Home Page.

FIG. 13 shows an example of a map of service users and reported beacons.

FIG. 14 shows an example of account information for a user.

FIG. 15 shows an example of details of a specific location report, indicating the user's estimated position, alongside details of how the location estimate was obtained.

FIG. 16 shows an example of a hardware system, the hardware system including mobile devices, beacons/base stations, a server and a database of beacon locations, the mobile devices submitting beacon sighing data via beacons to the server, the server using the beacon sighting data to build the database of beacon locations, and to improve the accuracy of the database, using force directed graph calculations.

FIG. 17 shows an example of the FIG. 16 implementation able to calculate the positions of the mobile devices using force directed graph calculations.

FIG. 18 shows a contact list in an Instant Messaging application, showing location information.

FIG. 19 shows how multiple contacts appear in the Instant Messaging application;

FIG. 20 shows how a map can be displayed to show a contact's location

FIG. 21 shows how a map can be displayed that shows the location of all members of a group.

### DETAILED DESCRIPTION

This section describes an implementation of the invention called Palringo Local: A Location-Aware Instant Messaging Presence Mobile Device Position Estimation Algorithm, and the Palringo Local Service Overview. These may be implemented in the context of the Palringo Vocal Instant Messaging service.

### 1. Palringo Local: A Location-Aware Instant Messaging Presence Mobile Device Position Estimation Algorithm

### Introduction

Radio hardware present in mobile devices can provide unique identifiers of fixed ‘beacons’ within the device's range. These beacons include Global System for Mobile communications (GSM) network cell identifiers, and in many cases fixed Wi-Fi® or Bluetooth® access points. By analysing information on local beacons, it is possible to approximate the location of such mobile devices. Palringo intends to utilise this location information to extend the presence and social networking features of the Palringo rich messaging service.

### Applications

There are numerous features within Instant Messaging (IM) and other types of Social Networking services which could benefit significantly from location awareness. The term ‘instant messaging’ will be used to refer to not only instant messaging applications, but any kind of social networking or community application or web site.

A non-exhaustive list of examples where location awareness is useful is provided in this section. Users often share “presence” information with their contacts. This allows their contacts to be notified of their current availability for communication and activities. By making use of real-time location information, the whereabouts of users can form part of their presence information. In an example scenario, Alice could glance at her contact list and instantly discover that Bob and Charlie are in the local area and likely to be available for a meeting.

Local clubs and communities could use or benefit from location-aware social networking to help discover and organise members in the local area. For example, when Alice visits the Lake District, she would be prompted to join the “sailing” group, which would allow her to converse with users in the area with mutual interests in activities. Location awareness also has significant applications in online dating. For example, Raymond has configured his Palringo-enabled device to alert him of the local availability of users matching specified criteria. Next time Alice is in the local area, Raymond is alerted to her proximity. Users within an enterprise can share their real-time location information, allowing them to easily coordinate communication between geographically dispersed team members. For example, Scott could glance at his contact list to see which of his mortgage advisors are closest to a client and available for a visit at short notice.

### Trilateration

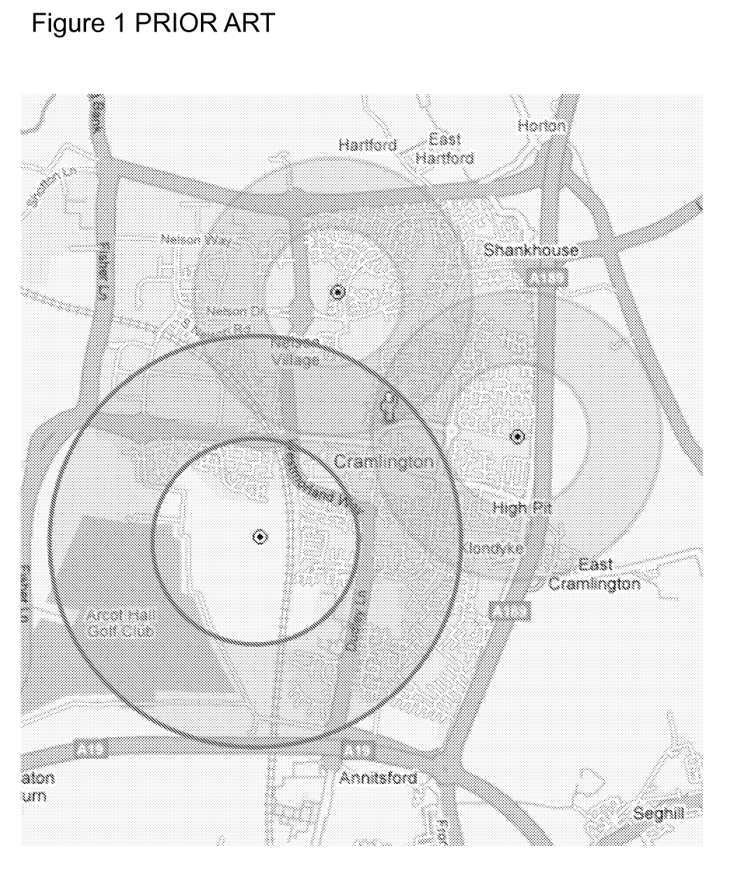

Mobile devices can execute software to periodically report unique identifiers and signal strengths of visible beacons (an example of ‘beacon sighting data’). If we know the positions of all the sighted beacons, it is trivial to make an educated guess as to the location of the device, using simple trilateration algorithms. This is demonstrated in FIG. 1, which demonstrates a method according to the prior art. Based on signal strength measurements, an estimate is made for the likely distance from each beacon. In FIG. 1, each area between two concentric circles shows the possible position of a user with respect to a beacon, based on the signal strength received from the beacon at the user's position. The user position is determined as shown to be in the region defined by the intersection region of the three areas, where each area is the area between two concentric circles, and where each circle is centred on a beacon.

### Problem Statement

Unfortunately, unique identifiers for sighted beacons cannot be directly mapped to a geographical location. Databases for the majority of network operators are unavailable in the public domain, and are not offered for purchase. If the user does not have a Global Positioning System (GPS) enabled device, or if he has a GPS enabled device but GPS reception is poor, such as in an area with tall buildings or from inside a building, and there is insufficient information about the sighted cells in our database, we are unable to determine the geographical position of the user.

### Previous Options

One option would be to use the Location Based Services (LBS) services provided by the network operators. Unfortunately, not all operators offer Location application programming interfaces (APIs). Furthermore, the pricing scheme for such services usually involves per-lookup costs, making them unviable for real-time tracking of a large user base. The traditional approach for implementing operator-independent location based services involves building up a database of cell site locations by using GPS-enabled devices to survey the target area. Surveying a wide area can be prohibitively expensive.

### Palringo Solution

The Palringo location algorithm attempts to map out the mobile network layout by inferring likely distance and direction relationships of submitted beacon sightings. In a hypothetical example, a user's device reports sighting of cells A, B, and C. The server does not have the location of any of these cells in its database, making a trilateration impossible. The server, however, can remember that cells A, B, and C are likely to be close to each other, as they were sighted simultaneously. If the location of any one of these cells becomes known in the future, the server could generate an educated guess for the locations of the other two. The Palringo location algorithm is self-tuning. The accuracy of location estimates will improve continuously as more data is fed into the system.

### Implementation

The Palringo location algorithm calculates the optimal placement of multiple nodes in 2D space using a force-directed graph algorithm. Essentially, the network topology is modelled as a physical system, with users and beacons modelled as “rings”, which are interconnected with “springs” that represent the inferred proximities. The algorithm may be adapted to function with three dimensional position data, such as in an environment with significant vertical elevation variation.

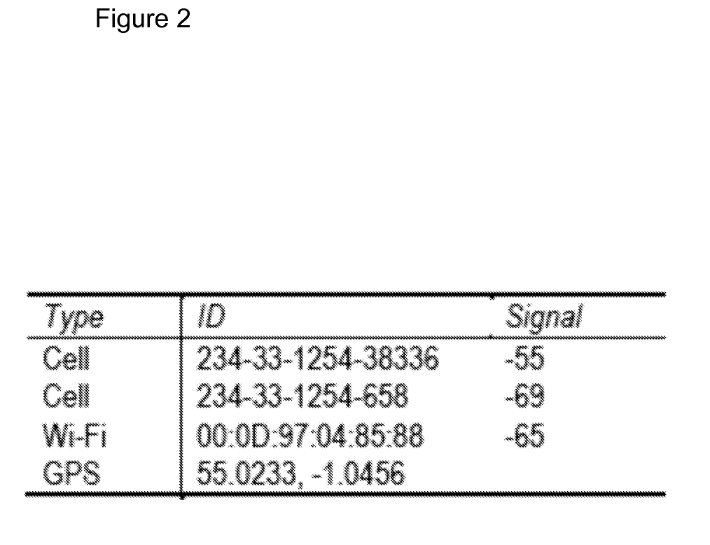

The user's device will frequently send “PLS SUBMIT” packets to the server. These contain details on all sighted beacons, (e.g. Cell ID, signal strength, timing information, cell advance timing information etc.) in addition to GPS fix details if available. An example of the information content of such a packet is given in FIG. 2.

The Palringo server stores these submissions in a database table, and uses them to generate a list of “nodes” and “edges”.

### Rings (Nodes)

Nodes represent points with unknown locations. These can be beacons, or the user's location at the time of a reported sighting.

### Springs (Edges)

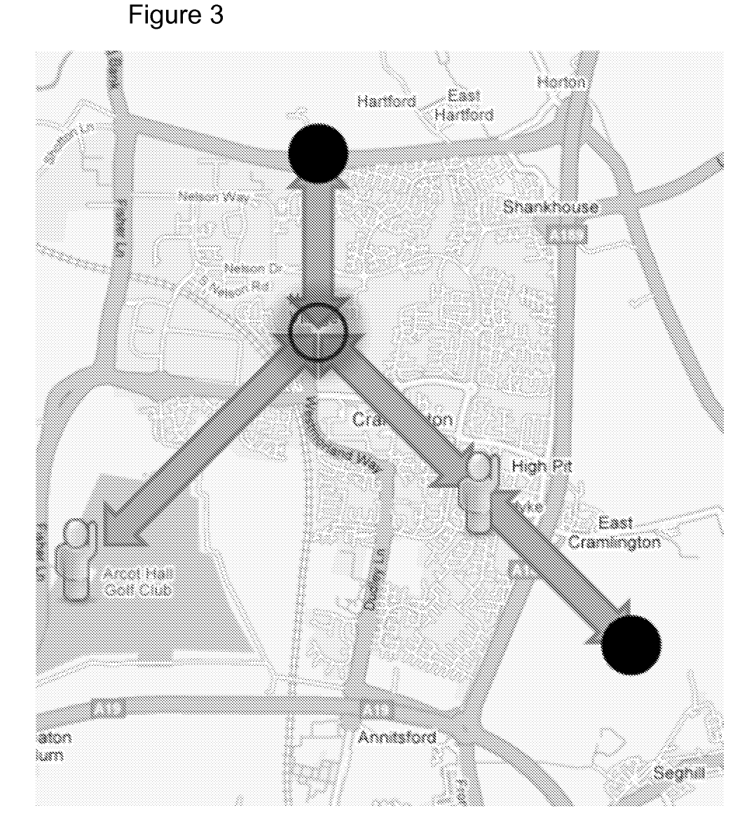

Edges represent connections between pairs of nodes that are likely to be proximate (eg. two beacons visible from the same point). We set their natural length to the estimated distance between the nodes, and their stiffness k to be proportional to the measurement accuracy in each case: that is, high accuracy implies high stiffness and low accuracy implies low stiffness. An example is shown in FIG. 3. In FIG. 3, the broad arrows represent springs, and the circle at the meeting point of three arrow heads represents a ring.

Once the list of nodes and edges has been generated, an iterative algorithm calculates an “attraction force” vector F for each spring, for example using Hooke's law;

F=−kx,

where x is the node displacement vector from the position defined by the spring's natural length, in the direction of the spring.

Each node is then repositioned to position vector A′ from position vector A based upon the total forces acting upon it i.e. using the equation

A′=A+□F,

where the symbol □ represents a vector summation over all the relevant forces. This describes one iteration. Subsequent iterations may be performed. With each iteration, the algorithm will converge on a more optimal solution. Subsequent iterations may be performed until a desired level of convergence of the nodes' positions is achieved eg. all the nodes move less than one metre between iterations.

### EXAMPLE

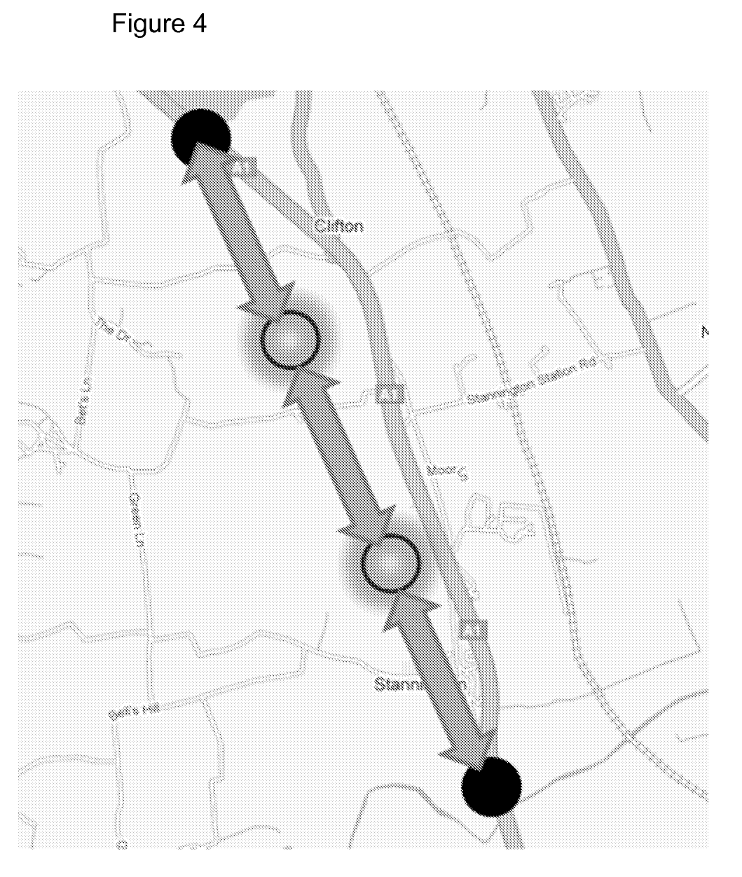

A user is driving down the A1 national route number in England. She passes a known cell, followed by two unknown cells, before sighting another known cell, as shown in FIG. 4. Black solid circles denote known cells; rings denote unknown cells. The algorithm assumes that the unknown beacons are spaced equidistantly on the geodesic line between the known beacons. (In other examples, the beacons need not be spaced equidistantly).

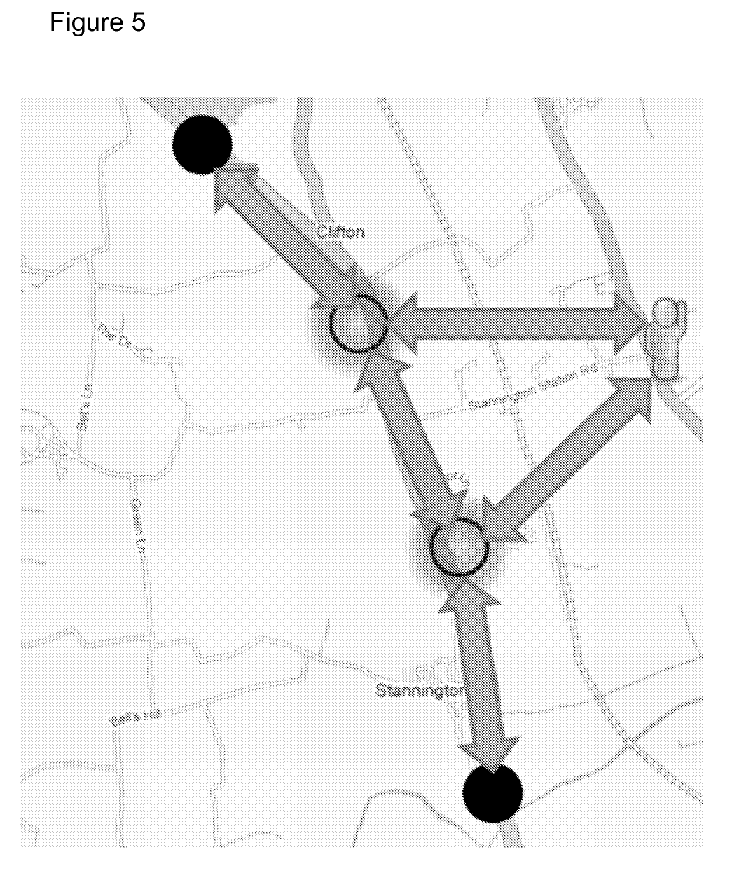

At a later point in time, the unknown beacons from the previous example are once again sighted, by a GPS-enabled device which is not on the A1 national route but is instead on another road, as shown in FIG. 5 by the position of the user to the right hand side of FIG. 5. The algorithm refines the estimates for the unknown nodes based on the new information, giving a more accurate layout for the mesh, shown in FIG. 5.

### Hardware

In an example of the invention, a hardware system is provided, the hardware system including mobile devices, beacons/base stations, a server and a database of beacon locations, the mobile devices submitting beacon sighting data via the beacons to the server, the server using the data to build/update the database of beacon locations.

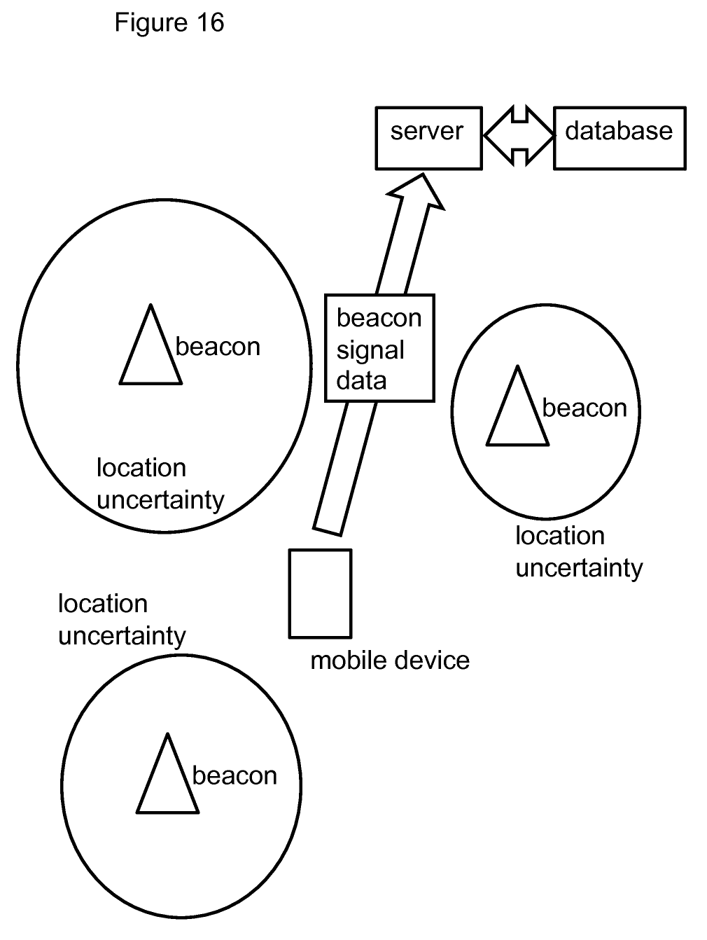

In an example of the invention, a hardware system is provided, the hardware system including mobile devices, beacons (i.e. receiver stations), a server and a database of beacon locations, the mobile devices submitting beacon sighting data via the beacons to the server, the server using the data to build/update the database of beacon locations, and to improve the accuracy of the database of beacon locations, using force directed graph calculations. An example is shown in FIG. 16.

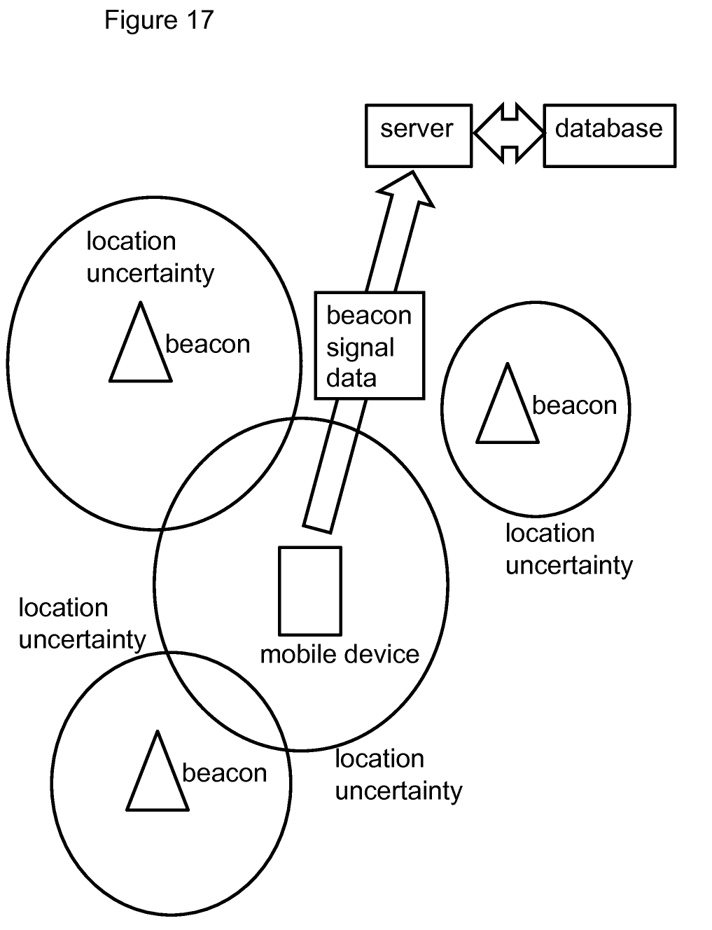

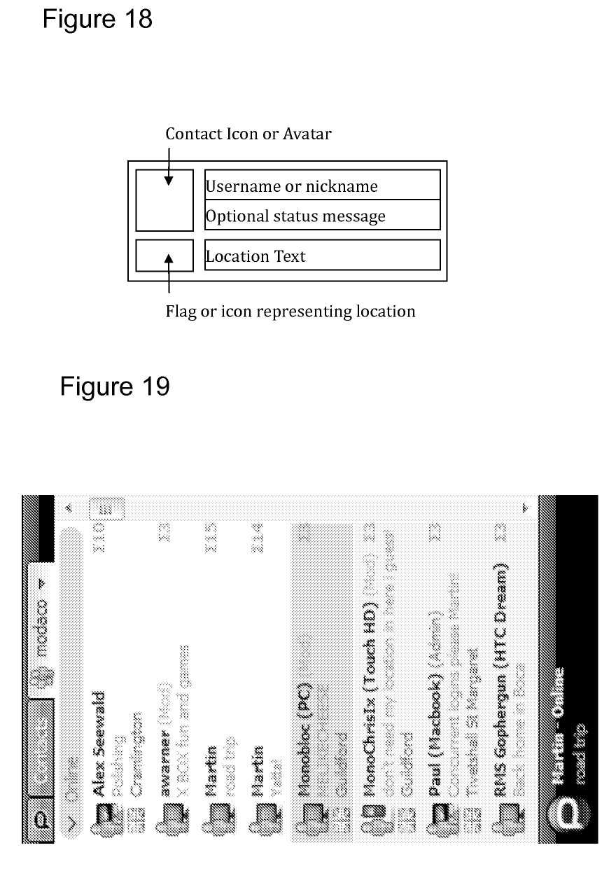

In a further example of the invention, the FIG. 16 implementation is used to calculate the positions of the mobile devices using force directed graph calculations. An example is shown in FIG. 17.

### SUMMARY

Palringo has developed a location estimation algorithm based on force-directed graph techniques. The algorithm is designed to work internationally, and across all network operators. For example, the algorithm can work in the vicinity of an international border, where received beacons are on either side of the border, or it can continue to work as a user moves from one country to another. It can quickly and autonomously learn enough data to provide inaccurate estimates of a user's general area. As more data is fed into the system, the accuracy of the data continuously improves.

### Note

As a result of the mobile device location determination capability, data can be collected by the server as a result of having the location capability. This includes data on device and network detail, location, message traffic and behaviour.

### 2. Palringo Local—Service Overview

### Introduction

Radio hardware present in mobile devices can provide unique identifiers of fixed ‘beacons’ within the device's range. These beacons include GSM network cell identifiers, and in many cases fixed Wi-Fi® or Bluetooth® access points. By analysing information on local beacons, it is possible to approximate the location of such mobile devices. Palringo intends to utilise this location information to extend the presence and social networking features of our product.

### Planned Functionality

Browsable online map of Palringo Users and known beacons
Web gadgets for forums/blogs/social networking sites displaying recent whereabouts
Highlighting of nearby users within the Palringo Client user interface (UI)
Location-specific Palringo groups/“Virtual Graffiti”

### Raw Data (PLS SUBMITs)

Reported by the phone every one minute
Contains a table of all visible beacons
Contains GPS fix data if available

An example is shown in FIG. 2.

### Ideal Scenario

If we know the positions of all the sighted beacons, it is trivial to make an educated guess as to the location of the device, as shown in FIG. 1. This scenario will initially be rare. For the majority of networks worldwide, we know exactly NOTHING about the cell-id: the cell-id is not equivalent to a position mapping. The service must be capable of learning both the location of users and sighted cells.

### Worst-Case Scenario

The user does not have GPS, and none of the sighted cells are in our database. We know absolutely nothing about the geographical position of the PLS SUBMIT. We still store the PLS SUBMIT, as it can be used to make useful inferences. For example, if cell X and Y are both visible in the submit, we know that cell X is near cell Y, even though we don't (yet) know where they are in absolute terms.

### The PLS Algorithm

To find the optimal placement of multiple nodes in 2D space, we use a force-directed graph based algorithm. This is shown in FIG. 3.

### Nodes (Modelled as Rings):

Locations of PLS SUBMITs, and sighted beacons. Some are anchored, some are free.

### Edges (Modelled as Springs):

Inferred relationships. Signal strength. Temporal proximity. User reports.

### Example 1

### Scenario

A user is driving down the A1 national route in England. She passes a known cell, followed by two unknown cells, before sighting another known cell.

### Result:

The algorithm assumes that the unknown beacons are spaced equidistantly on the geodesic line between the known beacons. This is shown in FIG. 4.

### Example 2

Scenario: The unknown beacons from the previous example are once again sighted, by a GPS-enabled device at the user position indicated in the right hand side of FIG. 5. Result: The algorithm refines the estimates for the unknown nodes based on the new information, giving an optimal layout for the mesh. This is shown in FIG. 5.

### Example 3

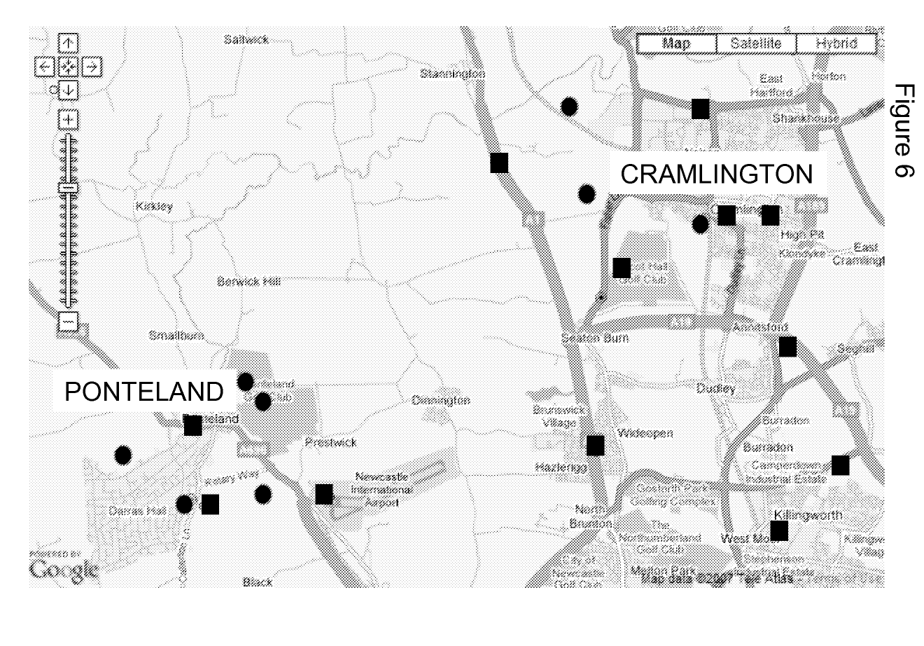

Visualisation of data collected from a single journey from Cramlington to Ponteland in England. Circular nodes were previously known. Square nodes show estimated positions for sighted nodes. This is shown in FIG. 6.

### Expectations

The system will work internationally, across all operators. It can quickly and autonomously learn enough data to provide inaccurate estimates of the user's general area. As more data is fed into the system, the accuracy of the data will improve significantly. To speed up the process, the database can be seeded by:
Operator LBS requests when stuck (no sighted cells are known)
Taking data from the Google Maps Mobile Cell Identification (ID) database (we reverse engineered the protocol)
GPS enabled devices, such as a handful of GPS enabled devices

### Technology Comparisons

Operator LBS Services:
Operators have the head-start of knowing the exact mast locations for their network.
Accuracy is limited. Typically the centre of the cell sector is returned.
Continuous tracking would be prohibitively expensive.

Google Maps Mobile (Recently added Location Feature)
Large database of approximate cell positions has been collected
We can tap this if necessary to help seed our database
Accuracy of the data is relatively low (2-5 km)
Database ˜90% complete for second generation wireless telephone technology (2G) cells and contains no third generation wireless telephone technology (3G) cells

### Client Side—Location Inference

Support for multiple sources of location information (e.g. any two or more of the following)
GPS Enabled Phones
Cell-ID based location inference
Heuristic learning of unknown cells
Manual entry/cell presets
   Display of information to the user
Display each source of location information
Display overall triangulated position estimate.

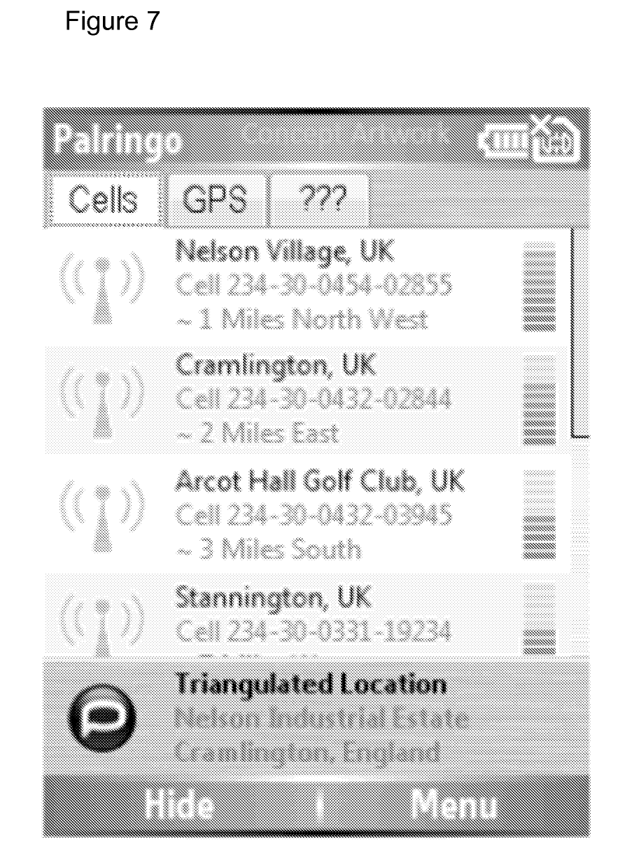

Stage 1 entails the development of a module to infer the phone's location. An example of output from the module is shown in FIG. 7.

### Client Side—Locations of Contacts

### Automatically Setting Status Message to Location

Configurable accuracy of shared location
Option 1—Preset (“Office, Home, School . . . ”)
Option 2—Country and city (“Cramlington, UK”)
Option 3—Place names (“Metro Centre, Gateshead”)

Permission levels may be different for authorized contacts than other users in a mutual group.

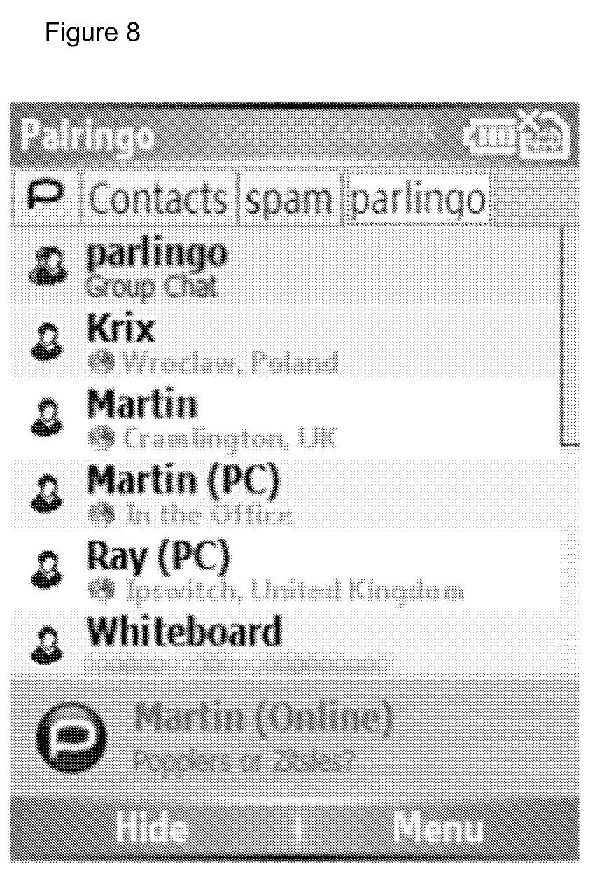

Stage 2 entails user-configurable options for sharing location information with other contacts. The location of users can be displayed as a strapline on the contact list. An example is shown in FIG. 8.

### Client Side-Who's Nearby? Proximity Alerts.

Display of Palringo users who are in the vicinity
Audible/Visual alerts when contacts are nearby
Configurable permissions
Personal contacts only
Group contacts
All Palringo users

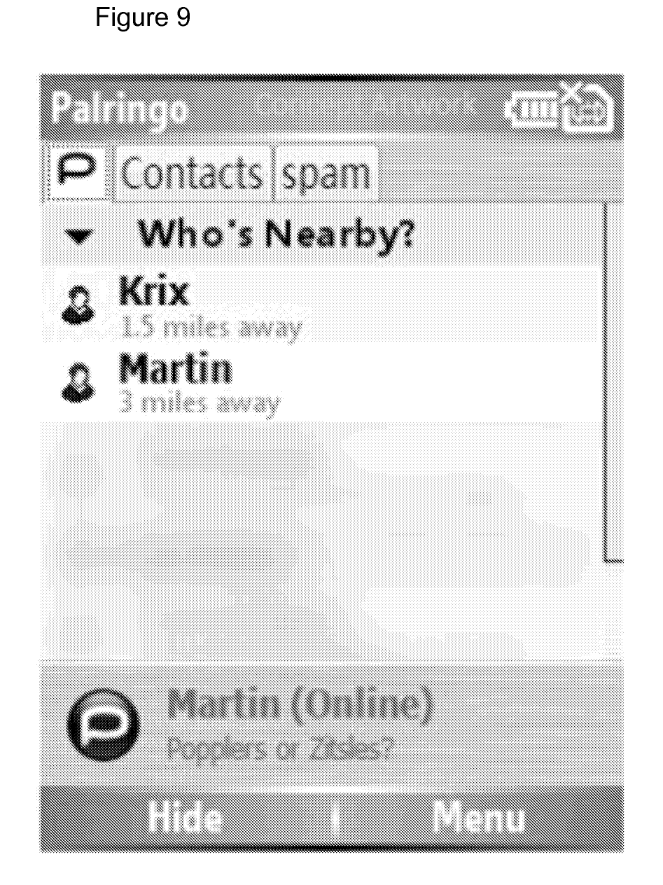

Stage 3 entails the development of an overview screen section which lists other Palringo users who are nearby. An example is shown in FIG. 9.

### Web Gadgets—Current Status and Location

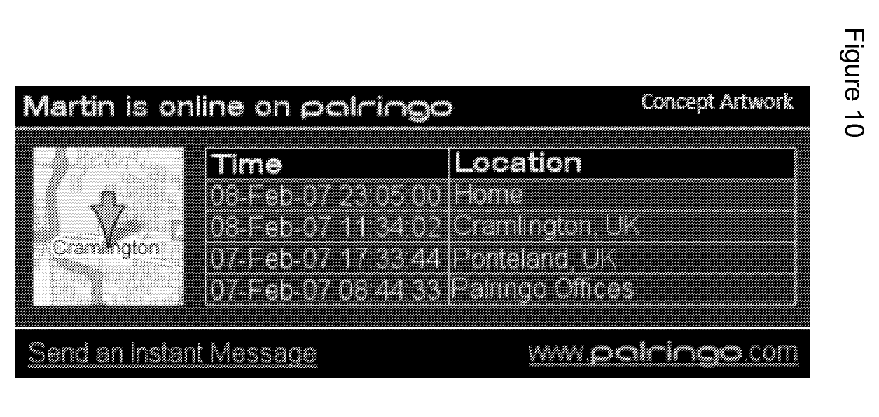

Creation of “Web Gadgets”—HyperText Markup Language (HTML) snippets which can be pasted into websites, blogs, social networking sites, etc. These can be configured to display palringo status and location. An example is shown in FIG. 10.

### Client Side—Local Map

Graphical display of position of self or other users.
Relevant map data downloaded on-demand
May use Google application programming interface (API)/MapPoint for geographic information system (GIS) data
Highlighting of cells and sector information used to infer location.

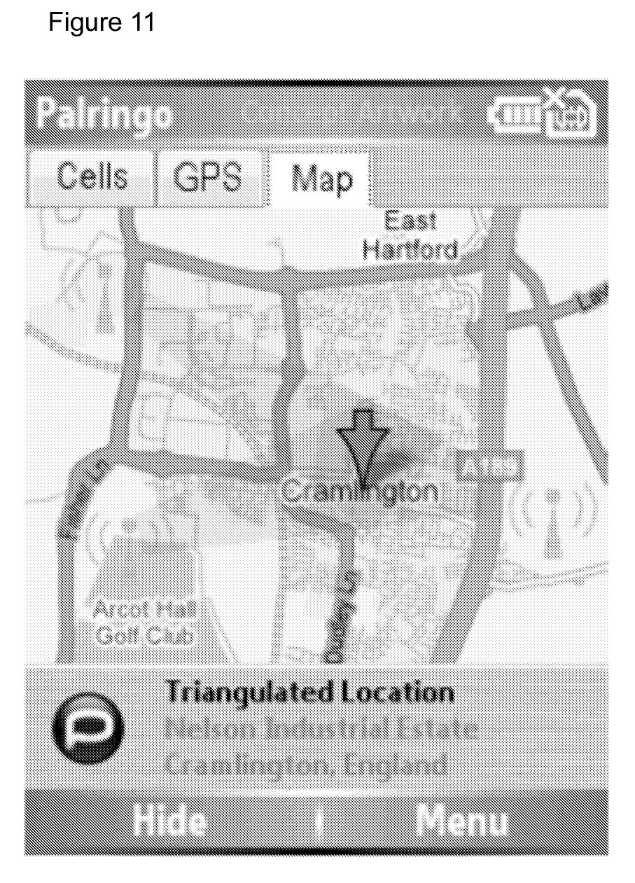

An example is shown in FIG. 11.

### Palringo Local Site Section—Home

An example of a Palringo Local Site Home Page is shown in FIG. 12.

### Local Site—Palringo Map

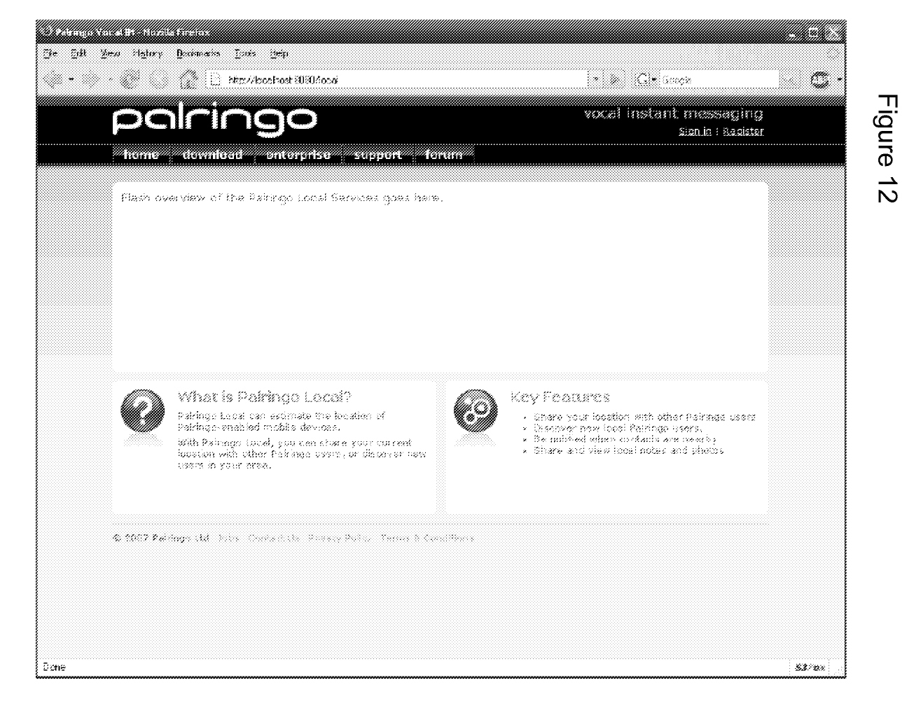

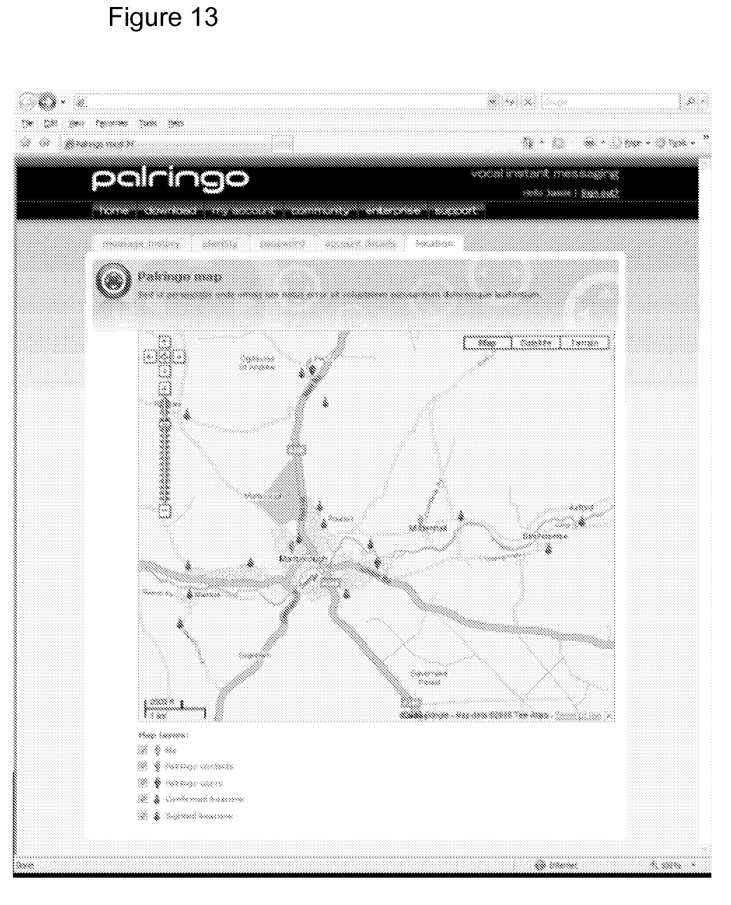

FIG. 13 displays an example of a map of Palringo users and reported beacons.

### Palringo Local Site Section—User

FIG. 14 shows an example of account information for a user. The report shows recent known or unknown whereabouts for a user. Clicking on a report can show additional information.

### Local Site—Location Report

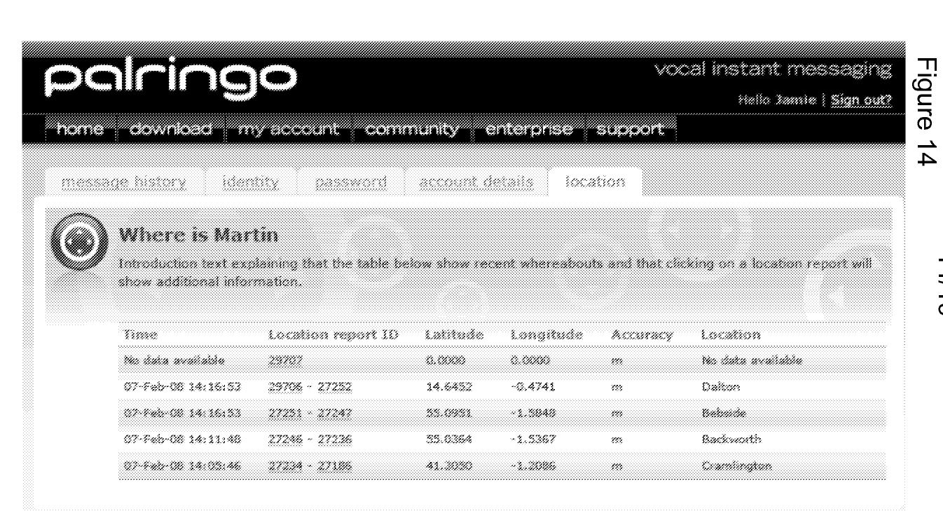

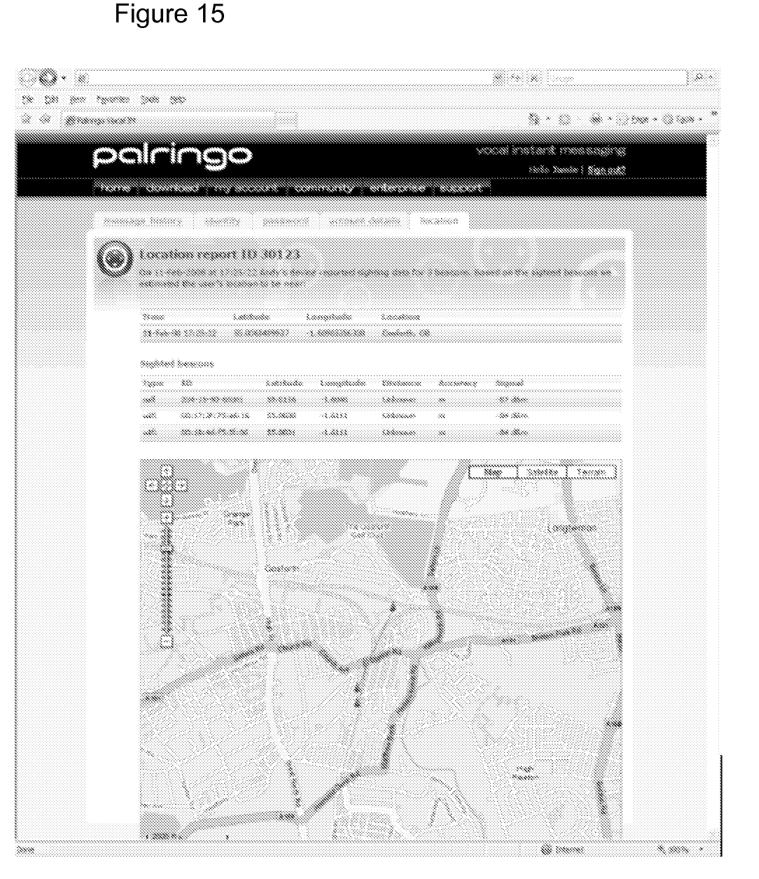

This page displays details of a specific location report, indicating the user's estimated position, alongside details of how the location estimate was obtained. An example is shown in FIG. 15.

### APPENDIX 1

This Appendix I describes an addendum to the Palringo Location Algorithm described above. It is a method of presenting location information in the context of an instant messaging and social networking contact list.

### Problem Statement

A continually evolving aspect of instant messaging services is the sharing of presence information between contacts.

For example, modern instant messaging services may allow users to indicate their availability and activities to other users.

Automatically sharing location information as part of IM presence offers a significant enhancement, by allowing users to infer answers to common questions like “where are you?” and “are you nearby?”.

This Appendix I describes an innovative method for presenting location information to users in the context of an IM buddy list.

### Palringo Solution

As with traditional contact lists, each contact is displayed as a separate line on a vertical list. However, if location information is available, an extra line is inserted with a human-readable representation of the geographical area. A plurality of such entries is displayed on one list, as shown in FIG. 19

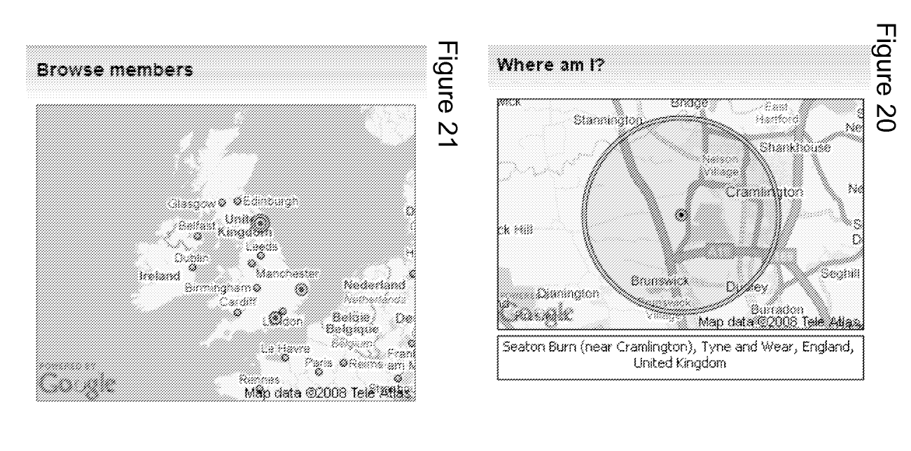

A contact properties screen can be directly invoked from the context of the contact list entry. This properties screen displays a map showing the selected contact's position, as shown in FIG. 20.

Social networking and instant messaging services often allow contacts to be organized in groups (chat groups or organizational groups). Such services may benefit from a map which simultaneously displays the location of all users in a specified group, as shown in FIG. 21.

### SUMMARY

Palringo has created an innovative method of integrating location functionality with instant messaging clients.

By using UI concepts outlined in this Appendix I, users can be made aware of the location of their IM contacts in real-time, providing them with significant hints as to their contact's availability and activities.

1. A method of building a database of beacon locations for a hardware system including mobile devices, beacons, and at least one server; the method comprising the steps of:
(i) the mobile devices submitting beacon sighting data to the server;
(ii) the server using the beacon sighting data to build the database of beacon locations using force directed graph calculations.

2. The method of claim 1 in which the beacon sighting data includes an ID for each beacon and signal strength data associated with each beacon; and an iterative process calculates the optimal placement of beacons in a 2D or 3D topology using force directed graph calculations without the need for any of the mobile devices to follow a re-defined route.

3. The method of claim 2 in which the 2D or 3D topology includes (a) nodes that represent points with unknown locations, such as beacons, or the user's location at the time of a reported sighting and (b) edges that represent connections between pairs of nodes that are likely to be proximate.

4. The method of claim 1 in which the location of an individual mobile device is inferred or derived from its distance from each of several beacons, the location of each of those beacons being listed in the database of beacon locations.

5. The method of claim 1 in which the location of an individual mobile device is inferred or derived from the database of beacon locations and that location is used in an instant messaging application running on or accessed by a different mobile device.

6. The method of claim 5 in which one or more contacts accessible to the instant messaging application is or are shown on the different mobile device together with a human-readable representation of the last known location of the associated mobile device, as inferred or derived from the database of beacon locations.

7. The method of claim 1, comprising the additional step of the server using the beacon sighting data to place unknown beacons on the line between known beacons.

8. The method of claim 1, in which a network topology is modelled as a physical system, with mobile devices and beacons modelled as nodes or “rings”, which are interconnected with edges or “springs” that represent inferred proximities.

9. The method of claim 8, in which a natural length of each spring is set to an estimated distance between the interconnected rings, and the stiffness k of each spring is proportional to the accuracy of the estimated distance between the interconnected rings.

10. The method of claim 9, in which a list of rings and springs is generated, and an iterative algorithm calculates an “attraction force” vector F for each spring.

11. The method of claim 10, in which the “attraction force” vector F for each spring is calculated using Hooke's Law.

12. The method of claim 10, in which in a single iteration each ring is repositioned to position vector A′ from position vector A based upon the total forces acting upon it, i.e. using the equation A′=A+ΣF, where the symbol Σ represents a vector summation over all the relevant forces and subsequent iterations are performed until a desired level of convergence of the rings' positions is achieved.

13. The method of claim 1, comprising the additional step of providing Web gadgets for forums or blogs or instant messaging or social networking sites displaying a user's recent location, as deemed or inferred from the database of beacon locations.

14. The method of claim 1, comprising the additional step of providing highlighting of nearby users within a client user interface.

15. The method of claim 1, in which location-specific user groups are identified.

16. The method of claim 1, comprising the additional step of seeding the database by Operator LBS requests when no sighted cells are known.

17. The method of claim 1, comprising the additional step of seeding the database by taking data from a third party Cell Identification (ID) database.

18. The method of claim 1, comprising the additional step of seeding the database by using GPS enabled devices.

19. A hardware system including mobile devices, beacons, and at least one server; in which:
(i) the mobile devices submit beacon sighting data to the server;
(ii) the server uses the beacon sighting data to build the database of beacon locations using force directed graph calculations.

20. A method of providing instant messaging in which the location of an individual mobile device is inferred or derived from a database of beacon locations and that location is used in an instant messaging application running on or accessed by a different mobile device, the database of beacon locations having been built using a method comprising the steps of:
(i) the mobile devices submitting beacon sighting data to the server;
(ii) the server using the beacon sighting data to build the database of beacon locations using force directed graph calculations.
